(19) United States
(12) Patent Application Publication
(10) Pub. No.: US 2022/0237286 A1
(43) Pub. Date: Jul. 28, 2022

(54) KERNEL BASED EXPLOITATION DETECTION AND PREVENTION USING GRAMMATICALLY STRUCTURED RULES

(71) Applicant: Malwarebytes Inc., Sata Clara, CA (US)

(72) Inventors: David Sánchez Lavado, Santurtzi (ES); Francisco Sánchez Peña, Santurtzi (ES)

(21) Appl. No.: 17/161,497

(22) Filed: Jan. 28, 2021

(51) Int. Cl. G06F 21/55; G06F 21/54; G06F 21/56

(52) U.S. Cl. CPC G06F 21/554; G06F 21/51; G06F 21/566; G06F 21/54

(57) ABSTRACT

An anti-exploitation application identifies and prevents a malicious action from occurring on a client. To do so, a monitoring system instantiated on the kernel of the operating system of the client. The monitoring system stores information describing actions taken by the processor. When the monitoring system detects a triggering action, it sends the triggering action to the anti-exploitation application to determine whether the triggering action is an exploitation action. The anti-exploitation application accesses an evidence set for the triggering action and its related actions. The anti-exploitation application generates an execution hierarchy defining the hierarchical relationships between the triggering action and its related actions and tests the hierarchy against a ruleset of grammatically structured rules. If a grammatically structured rule in the ruleset indicates that the triggering action is an exploitation action, the anti-exploitation application takes a prevention action.

### FIELD OF ART

The present disclosure generally relates to preventing system exploitation and more specifically to preventing exploits by monitoring an operating system kernel using grammatically structured rules.

### BACKGROUND

Anti-exploitation products, anti-malware, and other security software, employ signature-based and signature-less malware detection techniques. Anti-exploitation applications often monitor processor actions, but that monitoring does not necessarily reside high enough in a system hierarchy to prevent exploitations before they are executed by a processor. For instance, traditional anti-exploitation application may only monitor an action after it has occurred, and/or may not be able to prevent that exploit from occurring. As such, it would be beneficial to have an anti-exploitation application that could access and monitor processor actions at an apex level in a system hierarchy. For instance, as described herein, an anti-exploitation application that enables monitoring, tracking, and prevention of actions at a kernel of the operating system would be helpful.

### SUMMARY

Described herein is a method for an anti-exploitation application to identify and prevent an exploit before it occurs on a client. Herein, anti-exploitation refers to broadly to preventing a malicious or unwanted action from occurring on a client system. To prevent a malicious action, the anti-exploitation application instantiates a monitoring system on a kernel of an operating system. The monitoring system monitors actions (i.e., processor calls, processor executions, etc.) and stores information that may indicate whether the action is an exploitation action. The monitoring system sends any actions that have a high probability of being an exploitation action (i.e., a triggering action) to the anti-exploitation module for verification as to whether the action is an exploitation action or a benign action.

Responsive to receiving the triggering action, the anti-exploitation module accesses an evidence set for the triggering action. The evidence set is the stored information about the triggering action that may indicate whether it is an exploitation action. The evidence set may also include information for any actions related to the triggering action that may indicate whether it is an exploitation action.

The anti-exploitation application generates an execution hierarchy for the triggering action using the evidence set for the triggering action and its related actions. The execution hierarchy defines the hierarchical relationships between the triggering action and its related actions. The hierarchy can also include other information from the evidence set.

The anti-exploitation module accesses a rule list and applies rules of the rule list to the execution hierarchy to determine whether the triggering action is an exploitation action. For instance, each rule in the rule set may be a grammatically structured rule configured to identify, when applied to its execution hierarchy, whether a triggering action is a benign action. If one of the rules determines the triggering action is an exploitation action, the anti-exploitation application takes a prevention action to prevent the exploitation action from being executed by the processor.

There are several other prevention actions. For example, the prevention action can include moving files within the storage medium of the client such that the are inaccessible and inexecutable by the processor or application process. Additionally, the prevention action can notify the user of an exploit or transmit information regarding the exploit to a security server managing the anti-exploitation application.

In another embodiment, a non-transitory computer-readable storage medium stores instructions that when executed by a processor causes the processor to execute the above-described method.

In yet another embodiment, a computer system includes a processor and a non-transitory computer-readable storage medium that stores instructions for executing the above-described method.

### BRIEF DESCRIPTION OF THE DRAWINGS

The figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

FIG. 1 is a system diagram illustrating a system environment in which a protection application and a security server execute, according to one example embodiment.

FIG. 2 is an interaction diagram describing a process for preventing execution of an exploitation, according to one example embodiment.

FIG. 3 is a workflow diagram illustrating a client evaluating whether a triggering action is an exploitation action, according to one example embodiment.

### DETAILED DESCRIPTION

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### I. Introduction

Oftentimes, exploitation engineers are able to bypass the protections afforded by anti-exploitation applications. In one example, an exploitation engineer co-opts a processor running a trusted program that typically executes benign actions to execute unexpected exploitation actions. Because the exploitation action originates from a trusted program, the anti-exploitation application may not prevent the exploit from occurring and a client is compromised. One method to prevent this type of exploitation, as described herein, is monitoring all actions by a kernel of an operating system. In this manner, no matter where the exploitation action originates, an anti-exploitation application is able to prevent the exploit before it occurs.

### II. System Environment

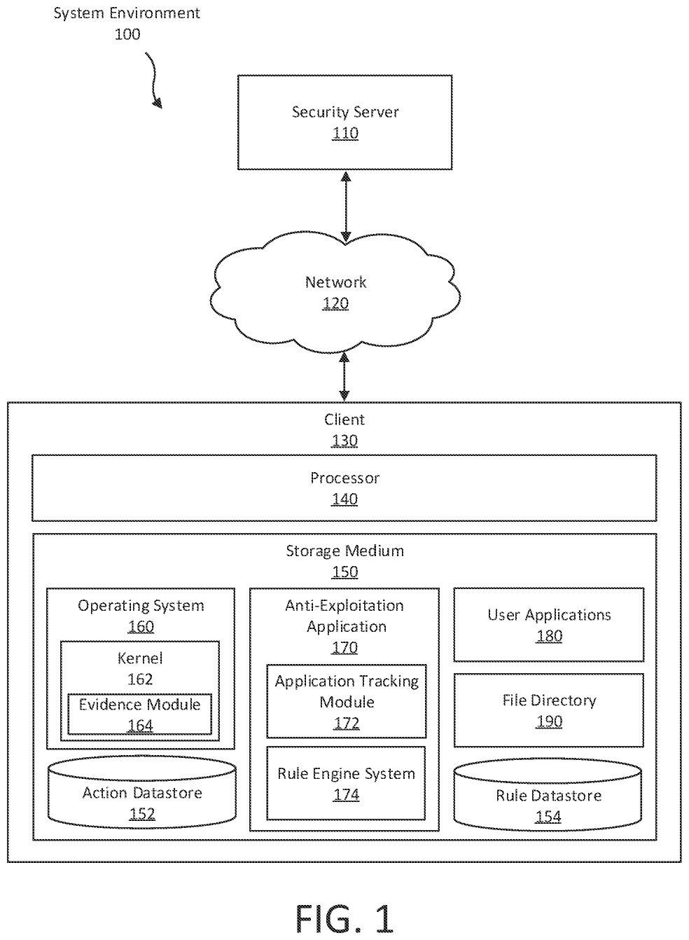

FIG. 1 is a system diagram illustrating a system environment in which a protection application and a security server execute, according to one example embodiment. The system environment 100 comprises a security server 110, a network 120, and a client 130 (also referred to as a client device 120). For simplicity and clarity, only one security server 110 and one client 130 are shown; however, other embodiments may include different numbers of security servers 110 and clients 130. Furthermore, the system environment 100 may include different or additional entities.

The security server 110 is a computer system configured to store, receive, and transmit data to clients 130 or to other servers via the network 120. The security server 110 may include a singular computing system, such as a single computer, or a network of computing systems, such as a data center or a distributed computing system. The security server 110 may receive requests for data from clients 130 and respond by transmitting the requested data to the clients 130. The security server 110 includes a database of information about known malware, known exploits, clean files, and known non-exploits. Known malware and exploits may be maintained in a “blacklist,” while clean files and non-exploits may be maintained in a “whitelist.” Further, the security server 110 may lookup files in whitelists or blacklists of the database and provide results of the lookup to clients 130. In aggregate, these may be referred to as “well-known lists.” In other words well-known lists contain a range of useful lists that can be used to identify exploits and malware. Well-known lists may include, for example, a list of opening file handles by a process, a whitelist of MD5 hashes of applications, a list of the application families (web-browsers, office apps, multimedia apps), or a blacklist of potential malicious file extensions and so on.

The security server 110 periodically sends whitelists, blacklists, or any other type of file or exploits signatures (“signatures”) to the client 130. In an embodiment, the security server 110 sends signatures to the client 130 ten times per day. A signature is data used to identify or verify the contents of a file, or the safety of an action execution. For example, a signature may be a sequence of bytes in a file's header, or may indicate a kernel 162 execution call. The signatures include signatures of whitelisted files and/or signatures of blacklisted files. In an embodiment, the signatures sent to the client 130 is a list of new signatures that have not yet been sent to the client 130. For example, the security server 110 may send five signatures to the client 130. Then the security server 110 may identify two new signatures and send the two new signatures to the client 130, expanding the client's 130 list of signatures to seven signatures.

The network 120 represents the communication pathways between the security server 110 and clients 130. In one embodiment, the network 120 is the Internet. The network 120 can also utilize dedicated or private communications links that are not necessarily part of the Internet. In one embodiment, the network 120 uses standard communications technologies and/or protocols. In addition, all or some of the links can be encrypted using conventional encryption technologies such as the secure sockets layer (SSL), Secure HTTP and/or virtual private networks (VPNs). In another embodiment, the entities can use custom and/or dedicated data communications technologies instead of, or in addition to, the ones described above.

Each client 130 comprises one or more computing devices capable of processing data as well as transmitting and receiving data via a network 120. For example, a client 130 may be a desktop computer, a laptop computer, a mobile phone, a tablet computing device, an Internet of Things (IoT) device, or any other device having computing and data communication capabilities.

Each client 130 includes a processor 140 for manipulating and processing data, and a storage medium 150 for storing data and program instructions associated with various applications. The storage medium 150 may include both volatile memory (e.g., random access memory) and non-volatile storage memory such as hard disks, flash memory, and external memory storage devices. In addition to storing program instructions, the storage medium 150 stores files in a file directory 190, as well as various data associated with operation of the operating system 160, anti-exploitation application 170, and other user applications 180.

In one embodiment, the storage medium 150 comprises a non-transitory computer-readable storage medium. Various executable programs (e.g., operating system 160, anti-exploitation application 170, and user applications 180) are each embodied as computer-executable instructions stored to the non-transitory computer-readable storage medium. The instructions, when executed by the processor 140, cause the client 130 to perform the functions attributed to the programs described herein.

The operating system 160 is a specialized program that manages computer hardware resources of the client 130 and provides common services to the user applications 180. For example, a computer's operating system 160 may manage the processor 140, storage medium 150, or other components not illustrated such as, for example, a graphics adapter, an audio adapter, network connections, disc drives, and USB slots. A mobile phone's operating system 160 may manage the processor 140, storage medium 150, display screen, keypad, dialer, wireless network connections and the like. Because many programs and executing processes compete for the limited resources provided by the processor 140, the operating system 160 may manage the processor bandwidth and timing to each requesting process. Examples of operating system 160s include WINDOWS, MAC OS, IOS, LINUX, UBUNTU, UNIX, and ANDROID.

The operating system 160 includes a kernel 162. The kernel 162 is the core of the operating system 160. Typically, the kernel 162 has control over all actions the processor takes on the client 130, and facilitates interactions between hardware (e.g., processor 140) and software components (e.g., user applications 180). For example, a kernel 162 may take actions to store a file in the file directory 190 or execute an action of a user application 180 on the processor 140. Other actions are also possible. The kernel 162 is usually loaded into a separate area of the storage medium 150 than other applications and that space is protected from access by other user applications 180, programs, or less critical components and processes. The kernel 162 performs its actions, such as running processes, managing hardware devices such as the hard disk, and handling interrupts, in this protected kernel 162 space.

Accordingly, anti-exploitation functionality of a client 130 may benefit from being able to access information from the kernel 162 space or control kernel 162 actions. In that regard, the kernel 162 includes an evidence module 164 that monitors actions taken by the kernel 162 and stores a record of those actions (and calls for those actions) in an action store 152. In some examples, rather than storing a record of the actions, the actions are transmitted to the anti-exploitation application 170. To illustrate, the evidence module 164 may monitor calls by the kernel 162 for the processor 140 to execute an action (e.g., open a user application 180) and store that call in the action store 152. As described below, the anti-exploitation module 170 may prevent the processor from taking that action (e.g., introducing an interrupt) if the action is an exploit. The functionality of the evidence module 164 is described in greater detail below.

The user applications 180 may include applications for performing a particular set of functions, tasks, or activities for the user. Examples of user applications 180 may include a word processor, a spreadsheet application, and a web browser. In some cases, a user application 180 can be a source of malware and may be associated with one or more of the files stored on the file directory 190 of the client 130. The malware may be executed or installed on the client 130 when the user application 180 is executed or installed, or when an associated malicious file is accessed.

The anti-exploitation application 170 detects, prevents, and remedies potentially malicious files and actions from being installed, stored, executed, etc. on the client 130 (in aggregate “exploitation actions”). The anti-exploitation application 170 includes an application tracking module 172 and a rule engine system 174 that act in concert with the evidence module 164 to prevent exploitation applications. In brief, to determine if an action is an exploitation action, the application tracking module 172 generates an execution hierarchy for the action using an evidence set from the evidence module 164 (e.g., any actions monitored by the evidence module 164 that may be pertinent to determining if the action is an exploitation action). The rule engine system 174 applies grammatically structured rules to the execution hierarchy to determine if it is an exploitation action. The rules are stored in a ruleset in the rule store 154. If the rule engine system 174 determines the action is an exploitation action, the anti-exploitation application 170 can perform a prevention action to prevent the exploitation action. The prevention actions may be keyed to the rule that indicated the action was an exploitation action or the type of exploitation action.

### III. Preventing Exploitation Actions

As described above, the anti-exploitation application 170 determines whether an action is an exploitation action or a benign action (i.e., “identifies an exploit”), and prevents a kernel 162 from performing the identified exploitation action by performing one or more prevention actions. An exploitation action is any action that, when executed by the processor 140, may act to exploit a vulnerability of a client 130. For example, exploitation actions can include installing malware, installing spyware, compromising system files, pirating processing power, etc. A benign action is any action that, when executed by the processor, does not exploit a vulnerability of client 130. For example, benign actions can include opening a whitelisted user application 180. A prevention action is any action that may prevent an exploitation action from occurring. For example, prevention actions can include: (1) stopping the kernel 162 from performing the exploitation action, (2) migrating one or more files associated with the exploitation action into a quarantine (such that the exploitation action cannot be executed by the kernel 162), (3) generating a notification that the exploitation action is an exploit for the client 130 and displaying the notification on the client 130, (4) transmitting a report to the security server 110 identifying the exploitation action and any corresponding evidence, (5) adding a user application 190 to a suspicious list, (6) adding a user application 190 to a whitelist, and (7) transmitting an action to the security server 110 for analysis. Other examples of exploitation actions, benign actions, and prevention actions are also possible.

To identify an exploit, the anti-exploitation application 170 leverages the evidence module 164 installed on the kernel 162. As described above, the evidence module 164 continuously monitors actions made by the operating system 160 (“monitored actions”), some of which are benign actions and some of which may be exploitation actions. Regardless of the type of monitored action, the evidence module 164 stores an action history for each monitored action in the action store 152. An action history includes any pertinent information that may indicate whether the monitored action is an exploitation action or a benign action.

To illustrate, an action history can include both static and dynamic data for a monitored action. Dynamic data may include whether the monitored action was previously executed, currently executing, or queued for execution. Dynamic data can further include the operating system 160 and module executing the monitored action. Moreover, dynamic data can also include loaded modules, file handles, networks sockets, etc. Static data can include the name, file path, command line, start time, completion time, execution time, user, familial relationships to other actions, etc. Additionally, the action history can also include static and dynamic data related to processes (e.g., user application 190) that were previously terminated. In this manner, the anti-exploitation module can leverage information from various applications and application processes to identify exploitation actions. In aggregate, the static and dynamic data, whether for a current process or a previously executed process, represent a snapshot of how the operating system 160 executes the monitored action.

The anti-exploitation application 170 evaluates whether a monitored action is an exploitation action or a benign action using the action history for that monitored action. However, evaluating every monitored action with the anti-exploitation application 170 is computationally expensive and impractical. As such, the anti-exploitation application 170 may only evaluate a monitored action if it is a triggering action. A triggering action may be a monitored action with a higher likelihood of being an exploitation action, i.e., actions more likely to need verification that they are a benign action. Some triggering actions may include, for example, executing a new process with the processor 140, interrupting a process currently executing on the processor 140, or some other action. As such, when the evidence module 164 detects a triggering action, it may provide that triggering action to the anti-exploitation application 170 for evaluation (rather than providing all monitored actions). Of course, which monitored actions are provided to the anti-exploitation application 170 as triggering actions is configurable by an administrator of the system environment 100 or a designer of the anti-exploitation application 170.

The anti-exploitation application 170 identifies whether a triggering action is an exploit by employing the application tracking module 172 to generate an execution hierarchy for the triggering action. An execution hierarchy defines the hierarchical relationships between the triggering action and any other related actions. Related actions may be any of: (1) actions having a familial relationship with the triggering action, (2) actions having the same type as the triggering action, (3) actions executed less than a threshold time-period before the triggering action, (4) actions executed by the same or different user application 180 as the triggering action, (5) actions executed by a related user application 180, (6) actions less than a threshold number of actions sequentially preceding the triggering action, (7) actions less than a threshold familial distance away from the triggering action (e.g., great-grandparents, second cousins, etc.), or (8) more generally, any actions related to the static or dynamic data in the action history for the triggering action. Other examples are also possible.

To generate the execution hierarchy, the application tracking application 170 accesses the action history for the triggering action and its related actions and uses the aggregated histories (“evidence set”) to generate the execution hierarchy for the triggering action. To illustrate, in an example, an execution hierarchy for a triggering action and its related actions may indicate parent and sibling relationship(s) between the triggering action and the related actions for the 10 preceding actions executed by the processor 140. A parent to child relationship is created when an action (e.g., a computer process such as execution of a user application 180) spawns another action (e.g., a subsequent process such as a different another user application 180). Parent actions, or processes, can have several children actions, or processes, depending on the configuration of the user application 180.

To continue, consider an example of the application tracking module 172 generating an execution hierarchy by accessing the evidence set for the triggering action and its related actions. Here, the evidence set indicates that the triggering action has several familial relationships (e.g., indicates a hierarchy of parent processes and child processes). For example, the triggering action is related to an action previously executed by the processor 140 which called the triggering action (“parent action”). Additionally, the evidence set indicates a familial relationship to several actions which were previously executed by the processor 140 which were also called by the parent action (“sibling actions”). The evidence set also indicates the familial relationships for parents, grandparents, siblings, cousins, etc. Moreover, as the application tracking module 172 generates the execution hierarchy, the corresponding action histories for each action in the hierarchy is associated with that action. In this manner, the execution hierarchy provides a robust roadmap of the triggering action and its related actions for analysis by the anti-exploitation application 170. Of course, this is just an example and other configurations of execution hierarchies, and methods of generating those execution hierarchies, are also possible, some of which are described herein.

The anti-exploitation application 170 identifies an exploit by engaging the rule engine system 174 to examine the execution hierarchy for the triggering action. To do so, the rule engine system 174 accesses a ruleset from the rule datastore 154 and applies the rules in the ruleset to the execution hierarchy. Each rule in the ruleset is configured to identify an exploit when applied to the execution hierarchy. That is, each rule tests whether the information and structure of the execution hierarchy is indicative of an exploitation action.

There are many configurations of rules and rulesets that can identify an exploit. In a configuration, the ruleset comprises a set of grammatically structured rules. In this case, the syntax and structure of each rule indicates how the rule will be applied to the execution hierarchy. For example, a grammatically structured rule may be structured to include three sections, with the position of each section in the structure indicating its functionality. For example, the three sections of the grammatically structured rule may be [Header; Conditions; Actions;]. Here, the Header section includes metadata information including the rule identifier, author, version, date, description, etc.; the Conditions section includes the conditional statements applied to the execution hierarchies that test whether the triggering action is an exploitation action; and, finally, the Actions section includes one or more prevention actions to implement if the conditional statements determine the triggering action is an exploitation action. Furthermore, the syntax in each section indicates how the functionality is applied. For example, the syntax of the Conditions section may be from a normalized grammatical system implemented by the security server 110 to identify exploits. Other examples are also possible.

Returning to the rule engine system 170 identifying an exploit, if an applied rule indicates that the triggering action is an exploitation action, the anti-exploitation application 170 may take a prevention action. In an embodiment, the anti-exploitation application 170 takes the prevention action corresponding to the rule that identified the exploitation action. To illustrate, consider a grammatically structured rule structured in a manner similar to the example above, e.g., (Header; Conditions; Actions;). In this situation, if the syntax in the Conditions section identifies the triggering action is an exploitation action, the anti-exploitation application 170 performs the prevention action indicated by the syntax in the Actions section. Of course, this methodology is just an example of determining and implementing prevention actions other configurations are also possible. For example, the anti-exploitation application 170 may perform a prevention action corresponding to the type of triggering action, the parent action, or a system setting (e.g., interrupt all identified exploits).

In the converse, if an applied rule indicates that the triggering action is a benign action, the anti-exploitation application 170 may allow the processor to perform the triggering action. Furthermore, the anti-exploitation application 170 may add the benign action to an action whitelist stored in the rule datastore 154. An action whitelist defines triggering actions that have been previously been identified as not being an exploitation action. Thus, the anti-exploitation application 170 may not evaluate a triggering action if it is on an action whitelist.

Action whitelists can also indicate other triggering actions that the anti-exploitation application 170 need not evaluate. For example, the action whitelist can indicate a type of triggering action that is a benign action. To illustrate, all triggering actions that access a specific location in the memory may be whitelisted actions. In another illustration, the action whitelist can indicate a suite of user applications 180. In this case, a triggering action originating from a user application 180 in the suite, and calling for execution of another user application 180 in the suite, need not be evaluated by the anti-exploitation application 170.

### IV. Anti-Exploit Configuration Variations

The configuration of the system environment 100 for identifying an exploit described herein has many different variations. For example, there is not necessarily a one to one correspondence between rules in a ruleset and an identified exploit. That is, the anti-exploitation application 170 can identify an exploitation action with one or more rules, depending on the exploitation action and the rules. In this case, the prevention actions may be implemented according to the grammatically structured rules, according to a prevention action hierarchy implemented by the security server 110, etc.

Furthermore, the system environment 100 may be configured such that the syntax and structure of the grammatically structured rules are normalized by the security server 110. In this manner, the security server 110 can more dynamically create and modify rulesets to combat rapidly changing exploitation technology. For example, the security server 110 can identify a new exploit, create a new grammatically structured rule according to the normalized structure and syntax, and rapidly deploy the new rule in the ruleset to clients.

Moreover, due to the normalized structure and syntax of a grammatically structured rules, the security server 110 may distribute rulesets as text files. In this case, the anti-exploitation application 170 accesses the text file when applying the rules of the ruleset to the execution hierarchy. Oftentimes the text file is encrypted and/or binarized within the system environment 100 such that it is not easily readable by exploitation engineers. Accordingly, the anti-exploitation application 170 is configured to decrypt the ruleset as necessary when identifying an exploit.

Additionally, rather than the anti-exploitation application 170 generating an execution hierarchy once a triggering action is received from the evidence module 164, the evidence module 164 may dynamically generate and store an execution hierarchy in the action datastore 152 as it monitors actions. In this case, when the anti-exploitation application 170 receives a triggering action from the evidence module 164, it accesses an execution hierarchy from the action datastore 152, rather than accessing an evidence set and dynamically generating the execution hierarchy.

In a similar example, the application tracking module 172 is responsible for managing action histories and generating evidence sets. That is, rather than the anti-exploitation application 170 generating an execution hierarchy once a triggering action is received from the evidence module 164, the evidence module 164 may intercept and transmit actions to the application tracking module 172. In this case, the application tracking module 172 may store action histories, request an evidence set, and generate an execution hierarchy when the application tracking module 172 receives a triggering action from the evidence module 164. At any point the application tracking module 172 may store action histories in an action data store 152.

Furthermore, the security server 110 dynamically and actively updates rulesets in order to prevent exploits from occurring on the client 130. To that end, the client 130 regularly receives updated rulesets from the security server 110 to store in the rule datastore 152. In some embodiments, the rulesets are distributed separately form the anti-exploitation application 170 such that it does not have to reinstall on the client after every change to the ruleset. In this manner, a security server 110 may send an update ruleset while the anti-exploitation application 170 is executing on the client 130.

Finally, the client 130 can aid dynamic generation of updated rulesets. For example, if the client 130 detects an exploitation action, the client 130 can transmit any of the triggering action, the related actions, the evidence set, and the execution hierarchy to the security server 110. The security server 110 may utilize that information to create and/or update rulesets.

### V. System Interactions in Preventing Exploitation Actions

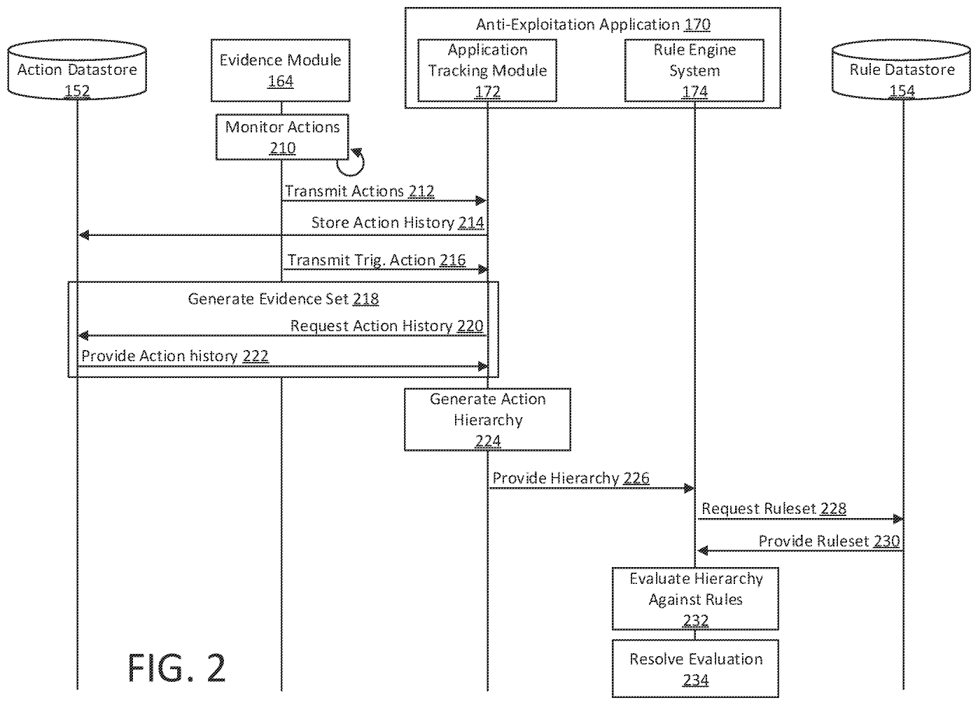

FIG. 2 is an interaction diagram describing a process for preventing execution of an exploitation, according to one example embodiment. Within the illustrated interaction diagram 200 the system environment 100 is similar to that described in FIG. 1 but could be another system environment 100.

FIG. 2 includes a horizontal line of shapes along the top of the figure (e.g., evidence module 164, action datastore 152, application tracking module 172, etc.). Each shape represents a different element within the system environment 100. Originating at the bottom of each shape is a line that stretches to the bottom of the figure. Boxes occurring on this line represent actions that occur at its corresponding element in the system environment 100. Similarly, arrows between lines represent interactions between the corresponding elements, with their directionality approximating the flow of information between those elements. Temporally, the actions and interactions in the interaction diagram 200 flow from the top of the figure to the bottom of the figure.

In the illustrated interaction diagram 200, the evidence module 164, action datastore 152, application tracking module 172, rule engine system 174, and rule datastore 154 reside on a client 130 configured to identify and prevent an exploit. As described in greater detail above, the evidence module 164 is installed on a kernel 162 of an operating system 160 and monitors actions the operating system 160 takes on a processor 140 of the client 130. Actions and their corresponding action history are stored in the action datastore 152. The application tracking module 172 manages actions and action histories and generates an execution hierarchy. The rule engine system 174 applies rules of a ruleset to the execution hierarchy to determine whether a triggering action is an exploitation action or a benign action. The ruleset is stored in the rule datastore 154.

To begin, an evidence module 164 is instantiated on the kernel 162 of the operating system 160. The evidence module continuously monitors 210 actions executed by the processor 140 at the behest of the operating system 160. For example, if the kernel 162 receives an instruction from a user to execute a user application 180, the kernel 162 causes the processor 140 to execute that user application 180. The evidence module 164 monitors those actions before, during, and after their execution.

The evidence module 164 transmits actions 212 to the application tracking module 172 and the application tracking module 172 stores 214 action histories in the action datastore 152 as needed. Included in the action history is any data associated with the action that may be useful for determining whether it is an exploitation action or a benign action.

While monitoring actions, the evidence module 164 may detect a triggering action and transmit the triggering action 216 to the application tracking module 172. Triggering actions are those the application tracking module 170 will evaluate as to whether they are an exploitation action or a benign action.

The application tracking module 172 receives the triggering action from the evidence module 164. The application tracking module 172 generates the evidence set 218 for the triggering action. To do so, that application tracking module 172 requests action histories 220 associated with the triggering action and its related actions from the action datastore 152 and the action datastore 152 provides the action histories 222 associated with the triggering action and its related actions in return. The application tracking module 172 generates an evidence set 218 that includes the action histories for the triggering action and its related actions.

The application tracking module 172 generates an execution hierarchy 224 for the triggering action using the evidence set. Generating the execution hierarchy creates a representation of the execution flow of the triggering action and its related actions on the client 130. The structure is generally defined by the parent and child relationships between the triggering action and its related actions and detailed with metadata from the evidence set.

The application tracking module 172 provides the execution hierarchy 226 to the rule engine system 174. The rule engine system 174 evaluates whether the triggering action is an exploitation action or a benign action. To do so, the rule engine system requests a ruleset 228 including grammatically structured rules from the rule datastore 154, and the rule datastore 154 provides the ruleset 230 to the rule engine system 174 in response.

To determine whether the triggering action is an exploitation action or a benign action, the rule engine system 174 evaluates the execution hierarchy against the ruleset 232. Evaluating the hierarchy includes applying each rule in the ruleset to the execution hierarchy to determine if that rule indicates the triggering action is an exploitation action.

The rule engine system 174 resolves the evaluation 234 based on if the triggering action is a benign action or an exploitation action. For example, if the triggering action is a benign action the rule engine system 174 may allow the processor 140 to proceed with executing the triggering action. However, if the triggering action is an exploitation action, the rule engine system 174 may take a prevention action. For example, the rule engine system may prevent the processor 140 from executing the triggering action. In various embodiments, the prevention action may be transmitted to the application tracking module 172 or evidence module 164 as needed for execution.

### VI. Workflow for Preventing Exploitation Actions

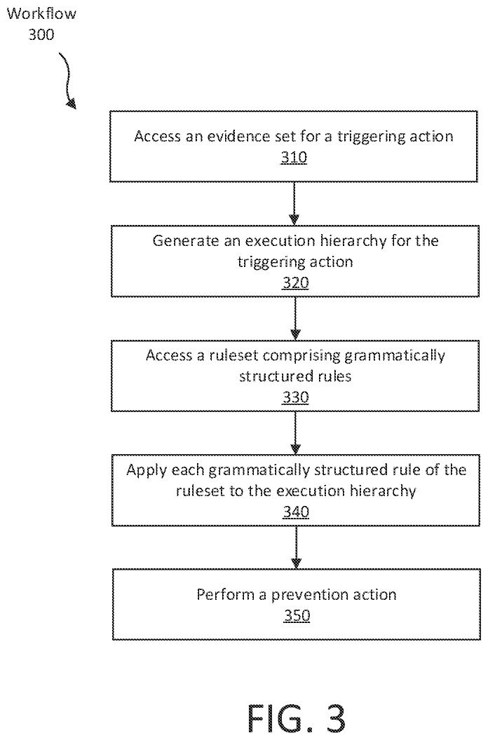

FIG. 3 is a workflow diagram illustrating a client evaluating whether a triggering action is an exploitation action, according to one example embodiment. As described, the workflow 300 describes the interactions in FIG. 2 as described from the viewpoint of the application protection application 170. In various embodiments, the workflow 300 may have more or fewer elements, and/or the elements may occur in some other order.

In the workflow 300 of FIG. 3, an evidence module 164 is executing on the kernel 162 of an operating system 160 and monitoring actions of the operating system 160 on the processor 140. Monitored actions and their action histories are stored in an action datastore 152. An anti-exploitation application 170 determines if any of the monitored actions are exploitation actions using a ruleset stored in a rule datastore 154.

The evidence module 164 detects a triggering action. Here, the triggering action is an execution call by the kernel 162 of the operating system 160 to open a user application 180, but it could be different triggering action. The evidence module 164 sends the triggering action to the anti-exploitation application 170.

Responsive to receiving the triggering action, the anti-exploitation application 170 accesses 310 an evidence set for the triggering action from the action datastore 152. The evidence set includes the action histories for the triggering action and its related actions describing their execution on the client 130. Here, the evidence set is a set of images describing familial relationships, static information, and dynamic information for the triggering action and its related actions.

The anti-exploitation application 170 generates 320 an execution hierarchy for the triggering action using the evidence set. The execution hierarchy defines the hierarchical relationships between the triggering action and its related actions. The execution hierarchy also reflects any or all of the corresponding information in the evidence set.

The anti-exploitation application 170 accesses 330 a ruleset from the rule datastore 154. The ruleset comprises a set of grammatically structured rules, with each grammatically structured rule configured to identify, when applied to the execution hierarchy of the triggering action, whether a triggering action is an exploitation action or a benign action.

The anti-exploitation application 170 applies 340 each grammatically structured rule in the ruleset to the execution hierarchy to determine whether the triggering action is an exploitation action. To expand, here, the grammatically structured rules include three sections. The first section includes header information for the rule; the second section comprises conditional statements that, when applied to an execution hierarchy, identify exploitation actions; and the third section comprises a prevention action that the anti-exploitation application 170 takes if its corresponding conditional rule statement identifies that an execution hierarchy is an exploitation action. Accordingly, applying the rules of the ruleset comprises applying the syntax of the conditional statements to the execution hierarchy to determine whether the triggering is an exploitation action.

Responsive to determining the triggering action is an exploitation action, the anti-exploitation application 170 performs 350 a prevention action. Here, the prevention action is included in the syntax of the third section of the grammatically structured rule whose conditional section identified the exploitation action. More specifically, in this example, the prevention action prevents the processor 140 from executing the exploitation action called by the kernel 162 of the operating system 160.

### VII. Additional Considerations

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A method for preventing exploitation of a computer processor, the method comprising:
responsive to receiving a triggering action representing an execution call by an operating kernel and before executing the triggering action on the operating kernel, accessing an evidence set comprising information describing execution of the triggering action and a plurality of related actions corresponding to the triggering action;
generating, using the evidence set for the triggering action and before executing the triggering action on the operating kernel, an execution hierarchy defining hierarchical relationships between the triggering action and the plurality of related actions;
accessing a rule list comprising a plurality of grammatically structured rules configured to identify whether the triggering action is an exploitation action for the operating kernel when applied to the execution hierarchy for the triggering action;
applying each grammatically structured rule in the rule list to the execution hierarchy to identify whether the triggering action is the exploitation action for the operating kernel; and
responsive to determining the triggering action is the exploitation action and before execution of the exploitation action by the operating kernel, performing a prevention action to prevent execution of the exploitation action called by the operating kernel by stopping the operating kernel from executing the triggering action on the operating kernel.

2. (canceled)

3. The method of claim 1, wherein performing the prevention action to prevent execution of the exploitation action by the operating kernel further comprises migrating one or more files associated with the triggering action into a quarantine such that the triggering action cannot be executed by the operating kernel.

4. The method of claim 1, wherein performing the prevention action to prevent execution of the exploitation action by the operating kernel further comprises:
generating a notification indicating the triggering action is the exploitation action; and
displaying the notification on a display of a system comprising the operating kernel.

5. The method of claim 1, wherein performing the prevention action to prevent execution of the exploitation action by the operating kernel further comprises:
transmitting, to a security management server, a report that both indicates the triggering action is the exploitation action and comprises the evidence set and the execution hierarchy for the triggering action.

6. The method of claim 1, wherein applying each grammatically structured rule to determine whether the triggering action is the exploitation action further comprises:
for each grammatically structured rule in the rule set:
accessing a conditional statement in the grammatically structured rule configured to identify one or more exploitation actions in the execution hierarchy;
evaluating the conditional statement against the execution hierarchy to determine whether one or more actions in the execution hierarchy are the exploitation action; and
wherein the conditional statement is indicated by its location within a grammatical structure of the grammatically structured rule.

7. The method of claim 1, wherein performing the prevention action to prevent execution of the exploitation action by the operating kernel further comprises:
accessing an action statement in a grammatically structured rule in the rule list that determined the triggering action was the exploitation action;
applying the action statement as the prevention action; and
wherein the action statement is indicated by its location within a grammatical structure of the grammatically structured rule.

8. The method of claim 1, further comprising receiving the rule list from a security management server configured to generate the grammatically structured rules in the rule list.

9. The method of claim 1, further comprising:
responsive to a security management system generating one or more additional grammatically structured rules configured to identify one or more additional exploitation actions, receiving an updated rule list from the security management server comprising the one or more additional rules.

10. The method of claim 1, wherein:
the rule set is configured to identify a plurality of exploitation actions, and
each grammatically structured rule of the rule set is configured to identify one or more exploitation actions of the plurality of exploitation actions in the rule set.

11. The method of claim 1, further comprising:
accessing an action white list comprising a plurality of benign actions previously identified as not being the exploitation action;
responsive to the triggering action being a benign action of the plurality of benign actions on the action white list, determining the triggering action is not the exploitation action without applying the grammatically structured rules of the rule list.

12. The method of claim 1, further comprising:
responsive to determining the triggering action is not the exploitation action, adding the triggering action to an action white list comprising a plurality of benign actions previously identified as not being the exploitation action; and
wherein the rule set is not applied to the triggering action after a future execution call for the triggering action by the operating kernel.

13. The method of claim 1, further comprising identifying an application class for the triggering action and wherein only grammatically structured rules corresponding to the application class are applied to the triggering action.

14. The method of claim 1, further comprising:
monitoring, in real-time, a plurality of execution calls by the operating kernel; and
responsive to an execution call of the plurality of execution calls having a verification call type, defining the execution call as the triggering action.

15. The method of 14, further comprising:
executing one or more actions corresponding to one or more of the plurality of execution calls by the operation kernel;
storing the one or more actions in a datastore; and
wherein accessing the evidence set for the triggering action comprises accessing one or more of the stored actions in the datastore as the plurality of related actions.

16. The method of claim 1, wherein the rule list is an encrypted binary file representing the plurality of grammatically structured rules.

17. The method of claim 1, wherein accessing the evidence set further comprises reading one or more execution images from a datastore.

18. The method of claim 1, wherein the evidence set comprises information for previously terminated actions executed by the operating kernel.

19. A non-transitory computer-readable storage medium storing computer instructions for preventing exploitation of one or more computer processors, the computer instructions, when executed by one or more processors, cause the processors to:
responsive to receiving a triggering action representing an execution call by an operating kernel and before executing the triggering action on the operating kernel, access an evidence set comprising information describing execution of the triggering action and a plurality of related actions corresponding to the triggering action;
generate, using the evidence set for the triggering action and before executing the triggering action on the operating kernel, an execution hierarchy defining hierarchical relationships between the triggering action and the plurality of related actions;
access a rule list comprising a plurality of grammatically structured rules configured to identify whether the triggering action is an exploitation action for the operating kernel when applied to the execution hierarchy for the triggering action;
apply each grammatically structured rule in the rule list to the execution hierarchy to identify whether the triggering action is the exploitation action for the operating kernel; and
responsive to determining the triggering action is the exploitation action and before execution the exploitation action by the operating kernel, perform a prevention action to prevent execution of the exploitation action called the operating kernel by stopping the operating kernel from executing the triggering action on the operating kernel.

20. A system for preventing exploitation of one or more computer processors, the system comprising:
one or more computer processors;
a non-transitory computer-readable storage medium storing computer program instructions, the computer program instructions executable by the one or more computer processors to perform operations comprising:
responsive to receiving a triggering action representing an execution call by an operating kernel and before executing the triggering action on the operating kernel, accessing an evidence set comprising information describing execution of the triggering action and a plurality of related actions corresponding to the triggering action;
generating, using the evidence set for the triggering action and before executing the triggering action on the operating kernel, an execution hierarchy defining hierarchical relationships between the triggering action and the plurality of related actions;
accessing a rule list comprising a plurality of grammatically structured rules configured to identify whether the triggering action is an exploitation action for the operating kernel when applied to the execution hierarchy for the triggering action;
applying each grammatically structured rule in the rule list to the execution hierarchy to identify whether the triggering action is the exploitation action for the operating kernel; and
responsive to determining the triggering action is the exploitation action and before execution of the exploitation action by the operating kernel, performing a prevention action to prevent execution of the exploitation action called the operating kernel by stopping the operating kernel from executing the triggering action on the operating kernel.
